(19) United States
(12) Patent Application Publication
(10) Pub. No.: US 2016/0148648 A1
(43) Pub. Date: May 26, 2016

(54) SYSTEMS AND METHODS FOR IMPROVING STABILIZATION IN TIME-LAPSE MEDIA CONTENT

(71) Applicant: Facebook, Inc., Menlo Park, CA (US)

(72) Inventors: Thomas Dimson, Stanford, CA (US); Alexandre Karpenko, Palo Alto, CA (US)

(21) Appl. No.: 14/548,914

(22) Filed: Nov. 20, 2014

(51) Int. Cl. G11B 27/031; G11B 27/00

(52) U.S. Cl. CPC G11B 27/031; G11B 27/005

(57) ABSTRACT

Systems, methods, and non-transitory computer-readable media can capture media content including an original set of frames. Motion data associated with the original set of frames can be acquired. A motion pattern can be determined based on the motion data. A subset of frames that are associated with the motion pattern can be identified out of the original set. A time-lapse media content item can be provided based on the subset of frames that are associated with the motion pattern.

### FIELD OF THE INVENTION

The present technology relates to the field of media content. More particularly, the present technology relates to techniques for improving stabilization in time-lapse media content.

### BACKGROUND

Today, people often utilize computing devices (or systems) for a wide variety of purposes. Users can use their computing devices to, for example, interact with one another, create content, share information, and access information. In some instances, a user of a computing device can utilize a camera or other image sensor of the computing device to capture or record media content, such as images and/or videos. In some cases, the user can utilize the camera to capture or record a time-lapse video.

In one example, the user can utilize the camera to facilitate creating a time-lapse video while he or she is walking, jogging, or running. Under conventional approaches, the walking, jogging, or running can introduce undesirable motion or instability, such as translational motion, into the imagery or visualization of the time-lapse media content being created. Similarly, in another example, when the user is creating time-lapse media content while riding a transportation vessel, such as a boat, there can be undesired motion in the resulting time-lapse media content created utilizing conventional approaches. Due to these and other reasons, conventional approaches can create challenges for or reduce the overall user experience associated with utilizing computing devices (or systems) to produce time-lapse media content.

### SUMMARY

Various embodiments of the present disclosure can include systems, methods, and non-transitory computer readable media configured to capture media content including an original set of frames. Motion data associated with the original set of frames can be acquired. A motion pattern can be determined based on the motion data. A subset of frames that are associated with the motion pattern can be identified out of the original set. A time-lapse media content item can be provided based on the subset of frames that are associated with the motion pattern.

In an embodiment, the acquiring of the motion data associated with the original set of frames can further comprise acquiring a set of timestamps associated with the original set of frames and acquiring a set of motion states from one or more motion sensors. In some instances, each motion state in the set of motion states can be associated with a respective timestamp in the set of timestamps. In some cases, the set of motion states can be represented in the motion data associated with the original set of frames.

In an embodiment, the determining of the motion pattern based on the motion data can further comprise analyzing the motion data to determine a set of motion states represented in the motion data. In some instances, the set of motion states can be analyzed to select a subset of motion states that satisfy specified motion consistency criteria. The motion pattern can include the subset of motion states.

In an embodiment, the identifying of the subset of frames, out of the original set, that are associated with the motion pattern can further comprise identifying the subset of frames to include a plurality of frames, out of the original set of frames, that have timestamps corresponding to timestamps associated with the subset of motion states.

In an embodiment, the motion data can be associated with a series of movements incurred by a user. The series of movements can include a plurality of repeated movements. In some instances, the plurality of repeated movements can be associated with the motion pattern. In some cases, the specified motion consistency criteria can require that each motion state in the subset of motion states is selected as being associated with a respective repeated movement in the plurality of repeated movements.

In an embodiment, the plurality of repeated movements can includes a plurality of undesirable translational movements. In some instances, the plurality of undesirable translational movements can include a plurality of undesired up-and-down movements.

In an embodiment, the series of movements incurred by the user can be associated with at least one of walking, jogging, or running. The plurality of repeated movements can be associated with at least one of an up-step, a down-step, or a recurring consistent movement present in the series of movements incurred by the user.

In an embodiment, the series of movements incurred by the user can be associated with at least one of a bicycle ride, a motorcycle ride, an automobile ride, a boat ride, or a plane ride. The plurality of repeated movements can be associated with a recurring consistent movement present in the series of movements incurred by the user.

In an embodiment, an orientation-based image stabilization process can be applied to the subset of frames prior to the providing of the time-lapse media content item.

In an embodiment, the acquiring of the motion data can utilize at least one of an accelerometer, a gyroscope, a magnetometer, a barometer, or a compass.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example translational motion stabilization time-lapse module configured to facilitate improving stabilization in time-lapse media content, according to an embodiment of the present disclosure.

FIG. 2 illustrates an example motion module configured to facilitate improving stabilization in time-lapse media content, according to an embodiment of the present disclosure.

FIG. 3 illustrates an example frame module configured to facilitate improving stabilization in time-lapse media content, according to an embodiment of the present disclosure.

FIG. 4 illustrates an example scenario associated with improving stabilization in time-lapse media content, according to an embodiment of the present disclosure.

FIG. 5 illustrates an example scenario associated with improving stabilization in time-lapse media content, according to an embodiment of the present disclosure.

FIG. 6 illustrates an example scenario associated with improving stabilization in time-lapse media content, according to an embodiment of the present disclosure.

FIG. 7 illustrates an example method associated with improving stabilization in time-lapse media content, according to an embodiment of the present disclosure.

FIG. 8 illustrates an example method associated with improving stabilization in time-lapse media content, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Improving Stabilization in Time-Lapse Media Content

People use computing devices (or systems) for a wide variety of purposes. Computing devices can provide different kinds of functionality. Users can utilize their computing devices to produce information, access information, and share information. In some cases, computing devices can be utilized to capture or record media content, such as time-lapse media content. Time-lapse media content can include, but is not limited to, time-lapse photographs or images, time-lapse videos, motion time-lapse media content, hyper-lapse media content, etc. Time-lapse media content can, for example, refer to media content that has been captured or recorded at a frame rate (e.g., a metric for measuring the frequency of frames) that is not greater than a frame rate at which the media content is played back or presented for viewing.

In one example, a user of a computing device that corresponds to or includes a camera can capture media content while he or she is walking, jogging, or running. Under conventional approaches, a time-lapse media content item generated based on the captured media content can incorporate undesirable motion caused by the walking, jogging, or running. The undesirable motion can, for example, include undesired translational motion, such as the up-and-down motion caused by each step of the walking, jogging, or running.

In another example, the user can attempt to produce time-lapse media content while in a transportation vessel. The transportation vessel can also introduce undesirable motion, such as the up-and-down motion of the boat at sea, into a time-lapse media content item created in accordance with conventional approaches.

As such, these and other similar conventional approaches can be ineffective, inefficient, and inconvenient. Therefore, an improved approach can be beneficial for addressing or alleviating various concerns associated with conventional approaches. The disclosed technology facilitates improving stabilization in time-lapse media content. Various embodiments of the present disclosure can capture media content including an original set of frames. Motion data associated with the original set of frames can be acquired. A motion pattern can be determined based on the motion data. A subset of frames that are associated with the motion pattern can be identified out of the original set. A time-lapse media content item can be provided based on the subset of frames that are associated with the motion pattern. It is contemplated that there can be many variations and/or other possibilities.

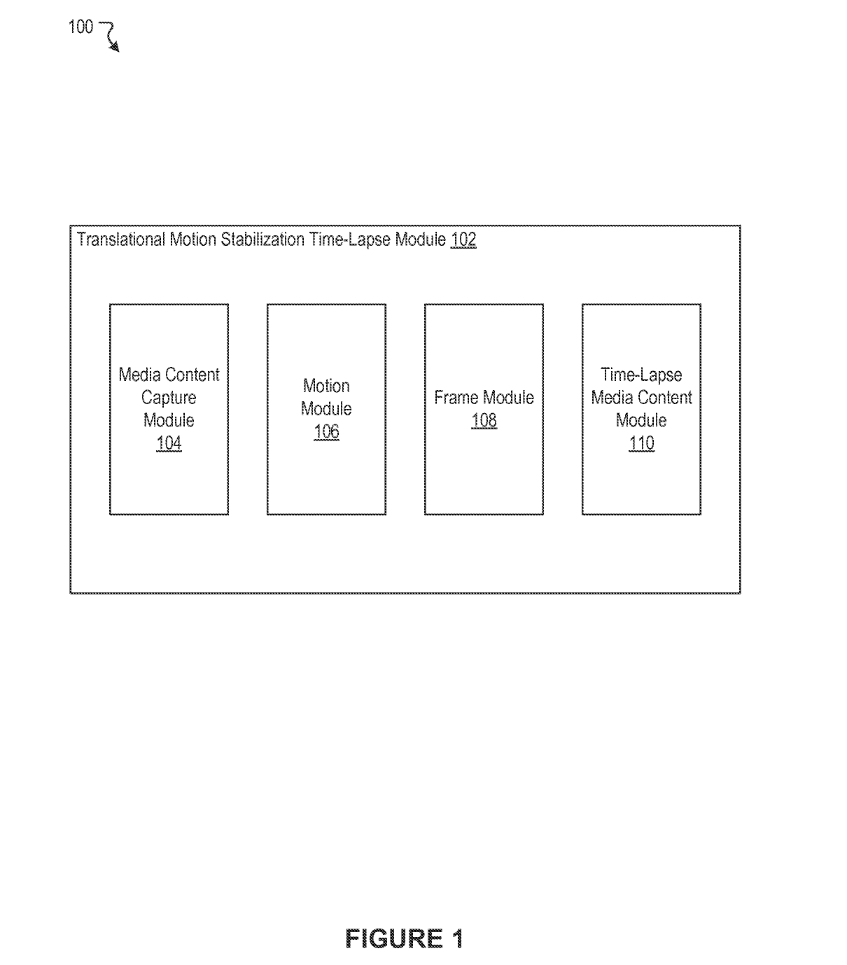

FIG. 1 illustrates an example system 100 including an example translational motion stabilization time-lapse module 102 configured to facilitate improving stabilization in time-lapse media content, according to an embodiment of the present disclosure. As shown in the example of FIG. 1, the translational motion stabilization time-lapse module 102 can include a media content capture module 104, a motion module 106, a frame module 108, and a time-lapse media content module 110. The components (e.g., modules, elements, etc.) shown in this figure and all figures herein are exemplary only, and other implementations may include additional, fewer, integrated, or different components. Some components may not be shown so as not to obscure relevant details.

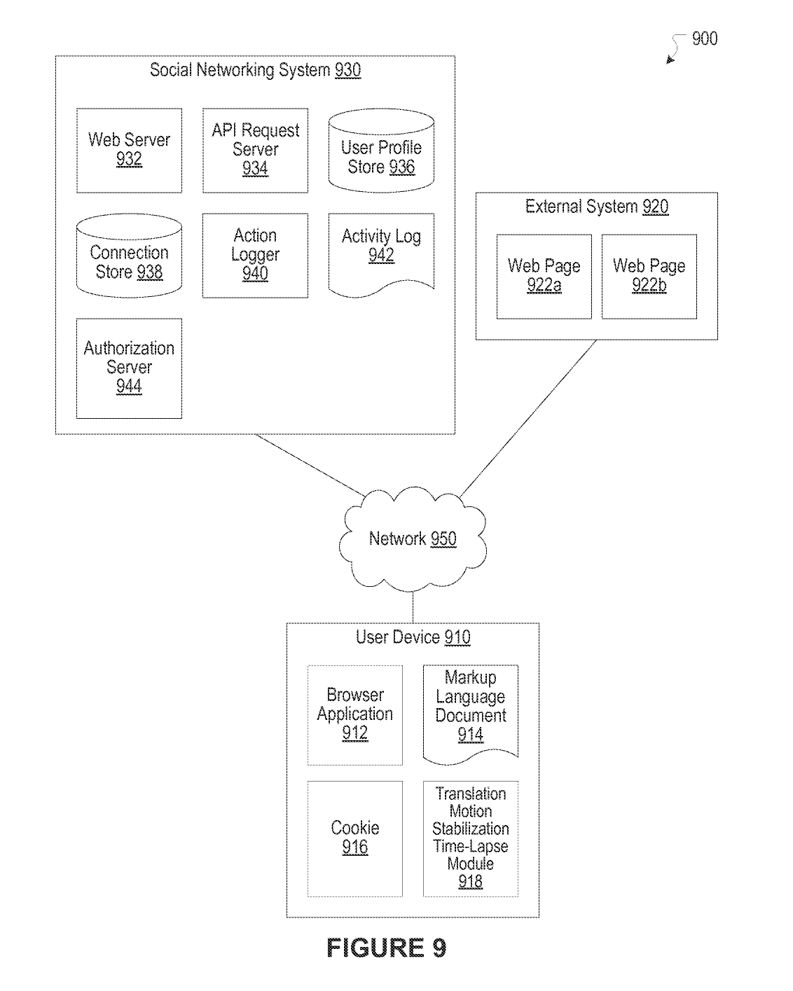

In some embodiments, the translational motion stabilization time-lapse module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the translational motion stabilization time-lapse module 102 can be implemented, in part or in whole, as software running on one or more computing devices or systems, such as on a user or client computing device. For example, the translational motion stabilization time-lapse module 102 can be implemented as or within an application (e.g., app), a program, or an applet, etc., running on a user computing device or client computing system. In another example, the translational motion stabilization time-lapse module 102 can be implemented using one or more computing devices or systems that include one or more servers, such as network servers or cloud servers. In some instances, the translational motion stabilization time-lapse module 102 can, in part or in whole, be implemented within or configured to operate in conjunction with a social networking system (or service), such as the social networking system 930 of FIG. 9. It should be understood that many variations are possible.

The media content capture module 104 can be configured to facilitate capturing media content including an original set of frames. In some embodiments, the media content capture module 104 can be configured to operate with a camera utilized by or otherwise associated with the translational motion stabilization time-lapse module 102. The media content capture module 104 can cause the camera to capture media content, such as a video or a series of images (e.g., still frames). The images or still frames can correspond to the original set of frames. In one example, the media content including the original set of frames can be captured or recorded at 24 frames per second, 30 frames per second, 60 frames per second, or another suitable rate.

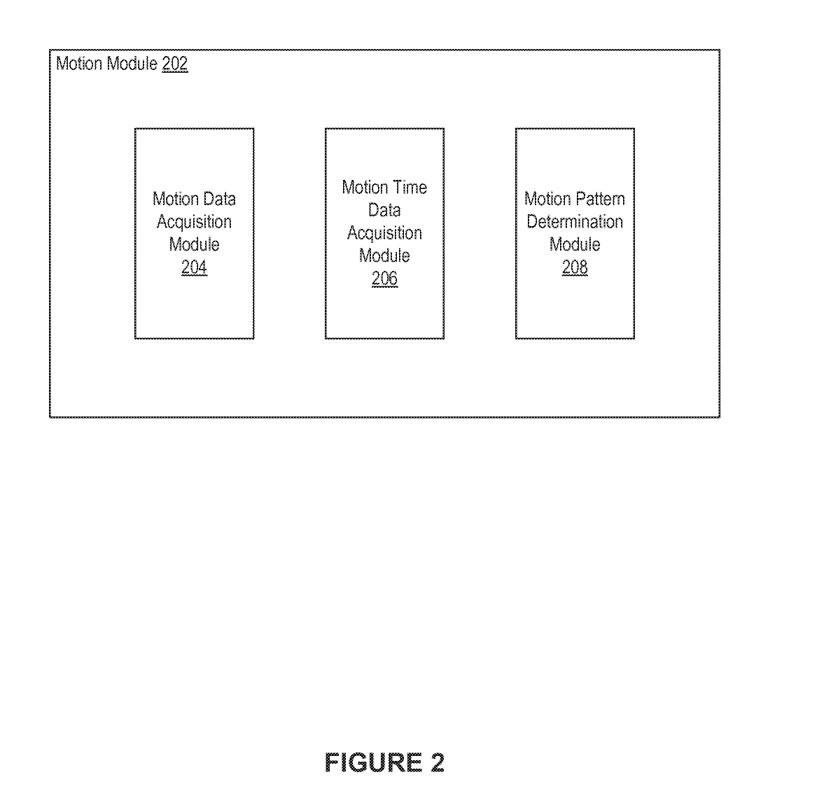

The motion module 106 can be configured to facilitate acquiring motion data associated with the original set of frames. For example, the motion module 106 can acquire information from one or more motion sensors, such as one or more motion processors, motion co-processors, and/or orientation sensors, etc. Based (at least in part) on the information from the one or more motion sensors, the motion module 106 can determine the motion data associated with the original set of frames. In addition, the motion module 106 can be configured to facilitate determining a motion pattern based on the motion data. In one example, based on the motion data, the motion module 106 can identify a sequence of recurring motions or movements that correspond to the motion pattern. It should be appreciated that there can be many variations and other possibilities. More details regarding the motion module 106 will be provided below with reference to FIG. 2.

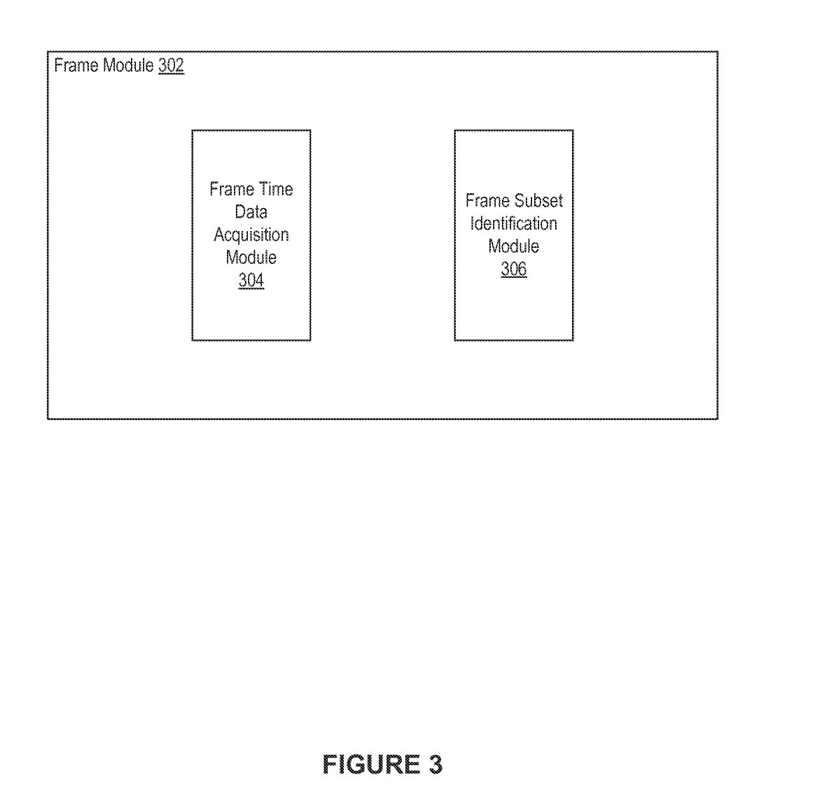

The frame module 108 can be configured to facilitate identifying a subset of frames, out of the original set, that are associated with the motion pattern. In one example, the frame module 108 can utilize time data (e.g., timestamps) associated with the motion pattern and time data associated with the original set of frames. In this example, the frame module 108 can utilize the time data to identify the subset of frames to include those frames, out of the original set, that are temporally associated with the motion pattern. The frame module 108 will be described in more detail below with reference to FIG. 3.

The time-lapse media content module 110 can be configured to facilitate providing a time-lapse media content item based on the subset of frames that are associated with the motion pattern. In some implementations, the time-lapse media content module 110 can assemble, combine, or otherwise process the subset of frames to generate and present the time-lapse media content item. For example, the time-lapse media content module 110 can sequentially stitch together each of the frames in the subset of frames to produce the time-lapse media content item.

Furthermore, in some embodiments, the time-lapse media content module 110 can be configured to facilitate applying an orientation-based image stabilization process to the subset of frames prior to the providing of the time-lapse media content item. In some instances, the orientation-based image stabilization process is similar to one or more processes described in U.S. patent application Ser. No. 14/101,252 titled “Systems And Methods For Digital Video Stabilization Via Constraint-Based Rotation Smoothing” and filed on Dec. 9, 2013, the entire contents of which are herein incorporated by reference. In some cases, the orientation-based image stabilization process applied by the time-lapse media content module 110 can acquire the subset of frames and information about the subset of frames, such as orientation data associated with the subset of frames. In some cases, orientation data can be acquired from one or more orientation sensors. In general, an orientation sensor can include any sensor or component configured to acquire, determine, detect, obtain, and/or receive data from which a device (or system) orientation can be derived, deduced, inferred, and/or approximated. For example, even though an accelerometer technically measures or acquires acceleration data, the acceleration data can be utilized, alone or in conjunction with other information, to determine an orientation or change in orientation for a computing device (or system) that includes the accelerometer. Accordingly, examples of the one or more orientation sensors can include, but are not limited to, an accelerometer, a gyroscope, a magnetometer, a barometer, or a compass, etc. The orientation-based image stabilization process can utilize, as input, the subset of frames and the orientation data associated with the subset to frames to produce or output a stabilized subset of frames. Accordingly, the providing of the time-lapse media content item can correspond to providing, based on the stabilized subset of frames, a stabilized time-lapse media content item.

In some instances, the orientation data can be associated with the subset of frames by being temporally associated with the subset. For example, the orientation data can include orientation data portions that have timestamps corresponding to timestamps of the subset of frames. Based (at least in part) on the subset of frames and the orientation data portions temporally associated with the subset, the orientation-based image stabilization process can produce the stabilized time-lapse media content item.

In one example, the orientation-based image stabilization process applied by the time-lapse media content module 110 can acquire camera (or device) orientation data having associated timestamps. The camera orientation data can indicate one or more orientations of a camera (or device) used to capture the media content including the original set of frames, from which the subset of frames is identified. The orientation-based image stabilization process can utilize camera orientation data portions with timestamps that correspond to the timestamps for the subset of frames. For example, each orientation data portion can have a timestamp that corresponds to a respective timestamp for each frame in the subset. The orientation-based image stabilization process can further generate a smoothed set of camera orientation data by minimizing a rate of rotation between successive frames in the subset while minimizing empty regions below a threshold. Furthermore, the orientation-based image stabilization process applied by the time-lapse media content module 110 can warp, rotate, skew, adjust, or otherwise modify the subset of frames based on the smoothed set of camera orientation data. Accordingly, the orientation-based image stabilization process can produce a warped or otherwise modified subset of frames, from which the stabilized time-lapse media content item can be generated or developed. It should be appreciated that there can be many variations, applications, and/or other possibilities.

In some cases, the stabilized time-lapse media content item can correspond to a stabilized hyperlapse media content item. For example, when the media content including the original set of frames is captured while the camera is moved across a distance over a duration of time, the stabilized time-lapse media content item can be produced as a stabilized hyperlapse media content item.

Furthermore, in some implementations, the orientation-based image stabilization process utilized by the time-lapse media content module 110 can apply adaptive zoom with respect to the subset of frames to produce the stabilized subset of frames. The adaptive zoom can, for example, be dependent upon the orientation data portions. In some cases, the adaptive zoom can include a technique for cropping or zooming frames, such as the subset of frames identified from the original set of frames. The adaptive zoom can allow individual frames to be translated, rotated, or warped to counteract undesired deformations introduced by hand shake or other undesirable changes in orientation. The amount of cropping or zooming can determine how much leeway (or “wiggle room”) is available to remove or reduce these deformations. If, for example, a particular frame is translated too far, empty regions (e.g., regions which have no pixel data) can be visible. The orientation-based image stabilization process can smooth out undesirable camera motion by counteracting changes in camera orientation, and can do so while preventing empty regions from showing up. The adaptive zoom can attempt to achieve an optimal or suitable zoom depending on the amount of changes in orientation.

For example, if the camera had undergone significant orientation changes, such as rotations (e.g., clockwise and/or counterclockwise relative to a lens of the camera), while capturing the media content, then the adaptive zoom can increase the zooming or cropping of the frames in the identified subset. If, however, the camera had undergone slight orientation changes (e.g., rotations), then the adaptive zoom can utilize a lesser zooming or cropping of the frames in the identified subset. There can be many variations and other possibilities.

FIG. 2 illustrates an example motion module 202 configured to facilitate improving stabilization in time-lapse media content, according to an embodiment of the present disclosure. In some embodiments, the motion module 106 of FIG. 1 can be implemented as the example motion module 202. In some instances, the example motion module 202 can be configured to acquire motion data associated with the original set of frames and to determine a motion pattern based on the motion data, as discussed above. As shown in FIG. 2, the motion module 202 can include a motion data acquisition module 204, a motion time data acquisition module 206, and a motion pattern determination module 208.

In some implementations, the motion data acquisition module 204 can facilitate the acquiring of the motion data associated with the original set of frames by acquiring a set of motion states from one or more motion sensors. The set of motion states can, for example, be included and/or represented in the motion data associated with the original set of frames. The one or more motion sensors can include, but are not limited to, motion processors, motion co-processors, accelerometers, gyroscopes, barometers, magnetometers, and/or compasses, etc. In general, a motion state can indicate a status, condition, and/or location, etc., relating to movement, position, orientation, acceleration, and/or motion. For example, the set of motion states acquired from the one or more motion sensors can indicate how a computing device (or system) including the motion sensors is moving over a duration of time, can indicate how the device is being orientated over time, and/or can provide rates of acceleration experienced by the device. In this example, each motion state can indicate how the device is positioned, orientated, situated at a respective particular point in time and/or how the device is experiencing or incurring motion, movement, acceleration at the respective particular point in time. The set of motion states can indicate a sequence of how the device is being positioned, oriented, situated, moved, and/or accelerated over time. Accordingly, the set of motion sets can be utilized to determine (e.g., detect, infer, approximate, etc.), inter alia, one or more translational movements experienced or incurred by the device.

In some cases, the each motion state in the set of motion states can be associated with time data. The motion time data acquisition module 206 can, alone or in conjunction with the motion data acquisition module 204, acquire or determine time data associated with each motion state in the set of motion states. In some implementations, the motion time data acquisition module 206 can acquire time data including timestamps associated with the set of motion states. The motion data acquisition module 204 can also utilize a set of timestamps associated with the original set of frames included in the captured media content. The set of motion states can be selected and acquired by the motion data acquisition module 204 such that each motion state in the set of motion states is associated with a respective timestamp in the set of timestamps associated with the original set of frames. Accordingly, based on the set of motion states, the motion module 202 can determine, infer, or approximate how each respective frame in the original set was situated, positioned, oriented, moved, and/or accelerated, etc., at the time the respective frame was captured.

Moreover, in some embodiments, the motion pattern determination module 208 can facilitate the determining of the motion pattern based on the motion data by analyzing the motion data to determine or identify the set of motion states represented in the motion data. For example, in some cases, the motion pattern determination module 208 can parse the motion data acquired by the motion data acquisition module 204 to recognize the set of motion sets represented in the motion data.

Furthermore, the motion pattern determination module 208 can be configured to facilitate analyzing the set of motion states to select a subset of motion states that satisfy specified motion consistency criteria. In some instances, the motion pattern can include the subset of motion states, such that the determining of the motion pattern can, for example, be based on the selecting of the subset of motion states that satisfy the specified motion consistency criteria.

In some cases, the motion data can be associated with a series of movements incurred or experienced by a user of the computing device (or system) that comprises the camera used for capturing the media content including the original set of frames. The series of movements can, for example, include a plurality of repeated movements, which can be associated with the determined motion pattern. In some instances, the specified motion consistency criteria require that each motion state in the subset of motion states is selected as being associated with a respective repeated movement in the plurality of repeated movements.

In some cases, the plurality of repeated movements can include a plurality of undesirable translational movements. The plurality of undesirable translational movements can include a plurality of undesired up-and-down movements. In one example, the series of movements incurred by the user can be associated with at least one of walking, jogging, or running, etc. The plurality of repeated movements can be associated with at least one of an up-step, a down-step, or a recurring consistent movement present in the series of movements incurred (e.g., experienced, performed, etc.) by the user. In another example, the series of movements incurred by the user can be associated with at least one of a bicycle ride, a motorcycle ride, an automobile ride, a boat ride, or a plane ride, etc. The plurality of repeated movements can be associated with a recurring consistent movement present in the series of movements incurred by the user. It should be contemplated that there can be many variations and other possibilities.

FIG. 3 illustrates an example frame module 302 configured to facilitate improving stabilization in time-lapse media content, according to an embodiment of the present disclosure. In some embodiments, the frame module 108 of FIG. 1 can be implemented as the example frame module 302. In some instances, the example frame module 302 can be configured to identify the subset of frames, out of the original set, that are associated with the motion pattern determined by the motion pattern determination module 208 of FIG. 2, as discussed above. As shown in the example of FIG. 3, the frame module 302 can include a frame time data acquisition module 304 and a frame subset identification module 306.

The frame time data acquisition module 304 can be configured to acquire time data, such as a set of timestamps, associated with the original set of frames. The set of timestamps associated with the original set of frames can, in some cases, be utilized by the motion data acquisition module 204 of FIG. 2 to facilitate selecting the set of motion states, such that each selected motion state in the set of motion states is associated with a respective timestamp in the set of timestamps associated with the original set of frames.

As discussed previously, the subset of frames that are associated with the motion pattern can be identified out of the original set of frames. In some embodiments, the frame subset identification module 306 can be configured to facilitate the identifying of the subset of frames by identifying the subset of frames to include a plurality of frames, out of the original set of frames, that have timestamps corresponding to timestamps associated with a subset of motion states that are included in, represented in, and/or otherwise associated with the determined motion pattern.

In one example, the frame subset identification module 306 can communicate and/or operate in conjunction with the frame time data acquisition module 304 to utilize the set of timestamps associated with the original set of frames. In this example, the frame subset identification module 306 can also communicate and/or operate with the motion time data acquisition module 206 of FIG. 2 to utilize the timestamps that are associated with the subset of motion states. The frame subset identification module 306 can compare the timestamps associated with the original set of frames and the timestamps associated with the subset of motion states. The frame subset identification module 306 can identify those frames, out of the original set, that have the same timestamps as the timestamps of the subset of motion states. The frame subset identification module 306 can cause the identified frames to be included in the subset of frames.

Continuing with the previous example, specified motion consistency criteria can require each motion state in the subset of motion states to correspond to or be associated with a down-step of a user who is walking while using the computing device with the camera to capture the original set of frames. As such, in this example, the frame subset identification module 306 can identify the subset of frames to include only those frames that are captured when the user is performing down-steps. Since each frame in the subset is captured when the user is down-stepping, inconsistencies in stability due undesired up-and-down translational motion can be reduced or eliminated. Subsequently, translational motion stabilization can be improved for the time-lapse media content item generated based on the identified subset of frames.

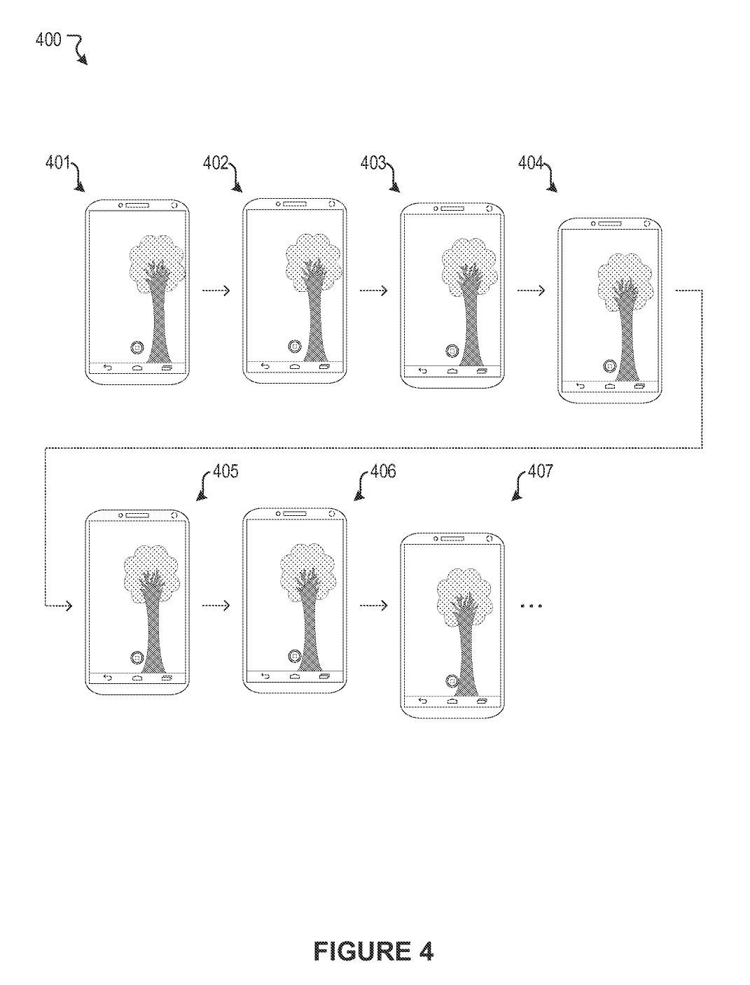

FIG. 4 illustrates an example scenario 400 associated with improving stabilization in time-lapse media content, according to an embodiment of the present disclosure. The example scenario 400 illustrates a computing device (or system) including a camera being used to capture media content including an original set of frames. In this example scenario 400, the original set of frames can include, but is not limited to, a first frame 401, a second frame 402, a third frame 403, a fourth frame 404, a fifth frame 405, a sixth frame 406, and a seventh frame 407.

In this example scenario 400, a user of the computing device with the camera can capture the media content while he or she is walking. In this example, the fourth frame 404 and the seventh 407 frame are captured while the user is down-stepping.

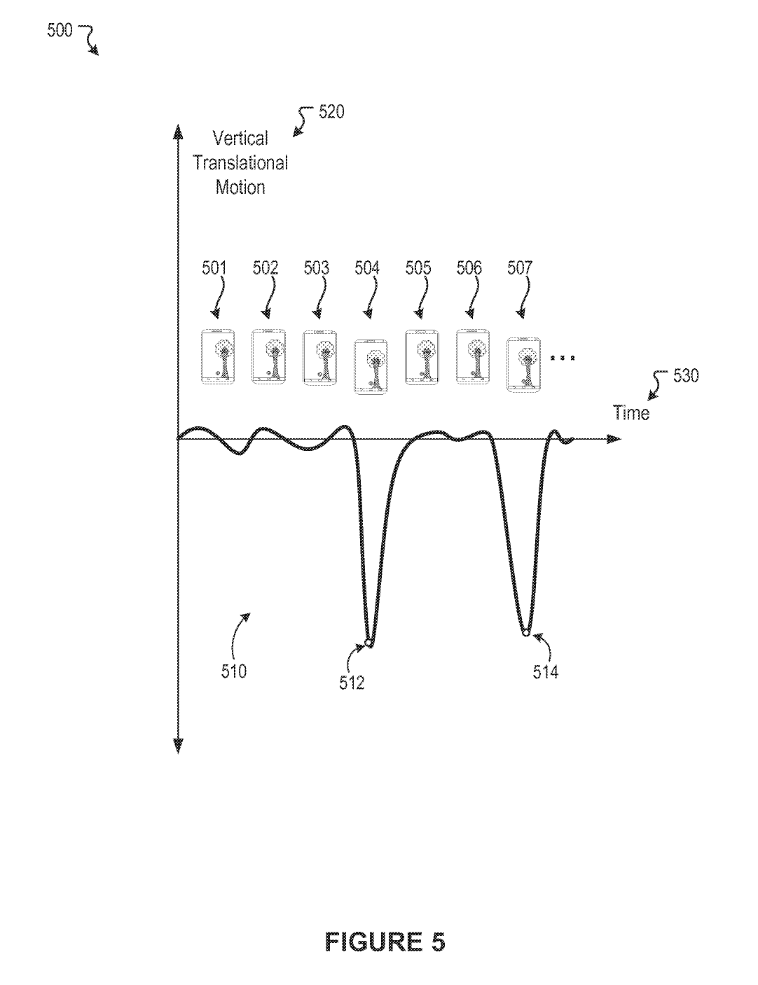

FIG. 5 illustrates an example scenario 500 associated with improving stabilization in time-lapse media content, according to an embodiment of the present disclosure. The example scenario 500 illustrates the computing device including the camera being used to capture the media content including the original set of frames (e.g., frames 501 through 507, frames 401 through 407 in FIG. 4).

The example scenario 500 of FIG. 5 also shows motion data 510 associated with the original set of frames. The motion data 510 is plotted in a graph having a vertical axis associated with vertical translational motion 520 and a horizontal axis associated with time 530. The motion data 510 can be plotted in the graph as a plurality of data points representing motion states. Based on time data associated with at least some of the motion states and time data associated with the original set of frames (e.g., frames 501 through 507), it can be determined how each respective frame in the original set was moved, positioned, oriented, and/or situated, etc., when the respective frame was captured.

In this example scenario 500, the user of the computing device with the camera can capture the media content while he or she is walking. The motion states can be utilized to determine that the fourth frame 504 and the seventh frame 507 in the original set were captured when the user was performing down-steps during his or her walk. The down-steps are repeated during the walk and are associated with a motion pattern. In this example, the motion pattern can include, be represented by, and/or be associated with a subset of motion states 512 and 514.

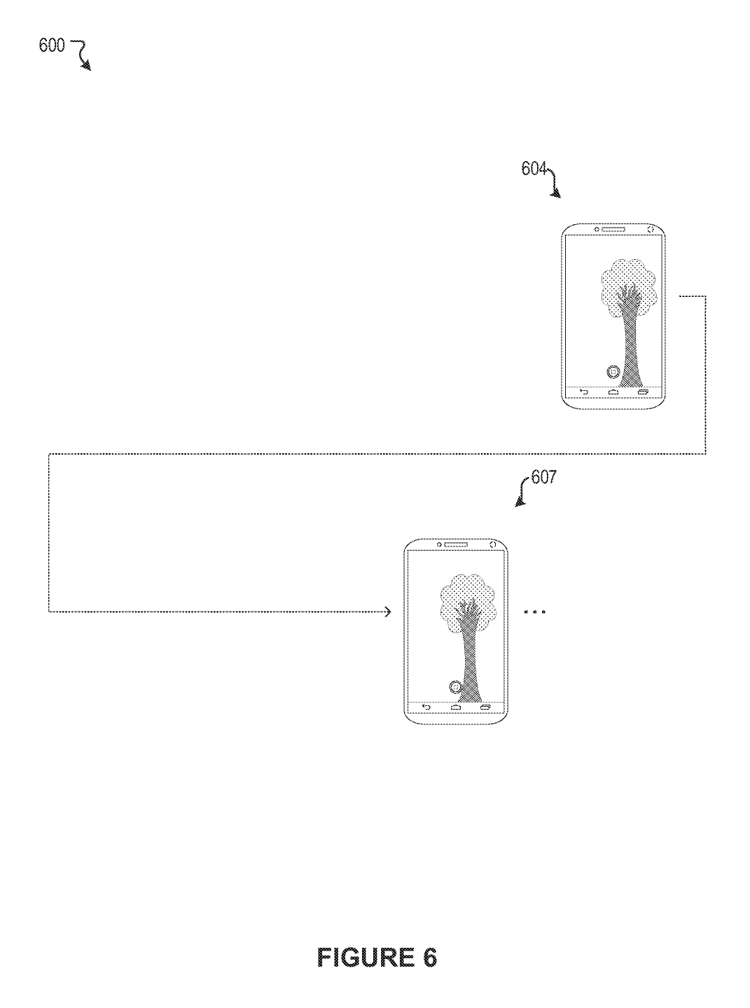

FIG. 6 illustrates an example scenario 600 associated with improving stabilization in time-lapse media content, according to an embodiment of the present disclosure. The example scenario 600 illustrates an identified subset of frames associated with the motion pattern of down-steps, as discussed previously with reference to FIG. 5. The identified subset of frames can include the fourth frame 604 (or frame 504 in FIG. 5) and the seventh frame 607 (or frame 507 in FIG. 5).

In this example scenario 600, the subset of frames can be identified as the frames, out of the original set, that have timestamps corresponding to timestamps associated with the selected subset of motion states (e.g., motion states 512 and 514 in FIG. 5). As discussed, the subset of motion states can be selected based on specified motion consistency criteria. In some cases, the specified motion consistency criteria can be set or defined by one or more system settings and/or user preferences. In this example, the specified motion consistency criteria can require that each motion state in the subset of motion states associated with the motion pattern is selected based on its association with a down-step. The selected subset of motion states can then be utilized to identify the subset of frames including, but not limited to, frames 604 and 607. Since the subset of frames (e.g., frames 604 and 607) were captured consistently when the user was down-stepping, a time-lapse media content item having improved translational motion stabilization can be generated based on the subset of frames. It should be appreciated that many variations are possible.

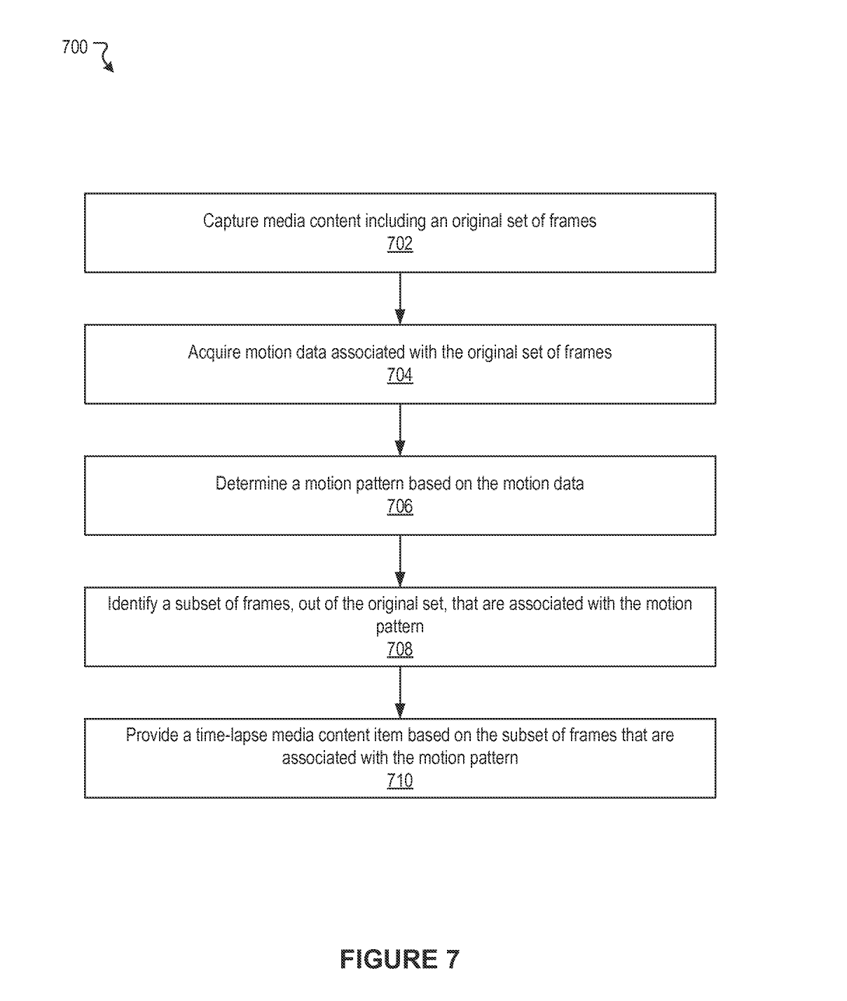

FIG. 7 illustrates an example method 700 associated with improving stabilization in time-lapse media content, according to an embodiment of the present disclosure. It should be appreciated that there can be additional, fewer, or alternative steps performed in similar or alternative orders, or in parallel, within the scope of the various embodiments unless otherwise stated.

At block 702, the example method 700 can capture media content including an original set of frames. At block 704, the example method 700 can acquire motion data associated with the original set of frames. At block 706, the example method 700 can determine a motion pattern based on the motion data. At block 708, the example method 700 can identify a subset of frames, out of the original set, that are associated with the motion pattern. At block 710, the example method 700 can provide a time-lapse media content item based on the subset of frames that are associated with the motion pattern.

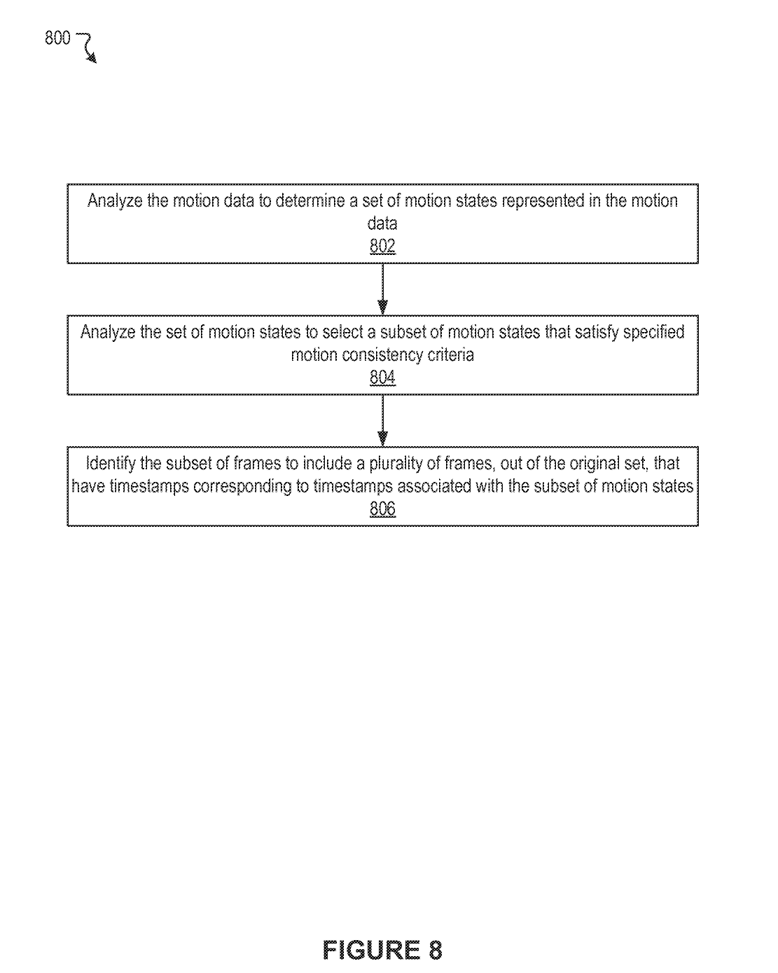

FIG. 8 illustrates an example method 800 associated with improving stabilization in time-lapse media content, according to an embodiment of the present disclosure. Again, it should be understood that there can be additional, fewer, or alternative steps performed in similar or alternative orders, or in parallel, within the scope of the various embodiments unless otherwise stated.

At block 802, the example method 800 can analyze the motion data to determine a set of motion states represented in the motion data. At block 804, the example method 800 can analyze the set of motion states to select a subset of motion states that satisfy specified motion consistency criteria. The motion pattern can include the subset of motion states. At block 806, the example method 800 can identify the subset of frames to include a plurality of frames, out of the original set of frames, that have timestamps corresponding to timestamps associated with the subset of motion states.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained. In another example, various embodiments of the present disclosure can learn, improve, and/or be refined over time.

### Social Networking System—Example Implementation

FIG. 9 illustrates a network diagram of an example system 900 that can be utilized in various scenarios, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices (or systems) that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920. In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the user device 910 can include a translational motion stabilization time-lapse module 918. The translational motion stabilization time-lapse module 918 can, for example, be implemented as the translational motion stabilization time-lapse module 102 of FIG. 1. The translational motion stabilization time-lapse module 918 can be configured to facilitate capturing media content including an original set of frames. The translational motion stabilization time-lapse module 918 can be further configured to facilitate acquiring motion data associated with the original set of frames. In addition, the translational motion stabilization time-lapse module 918 can be configured to facilitate determining a motion pattern based on the motion data. The translational motion stabilization time-lapse module 918 can also be configured to facilitate identifying a subset of frames, out of the original set, that are associated with the motion pattern. Furthermore, the translational motion stabilization time-lapse module 918 can be configured to facilitate providing a time-lapse media content item based on the subset of frames that are associated with the motion pattern. Other features of the translational motion stabilization time-lapse module 918 are discussed herein in connection with the translational motion stabilization time-lapse module 102.

### Hardware Implementation

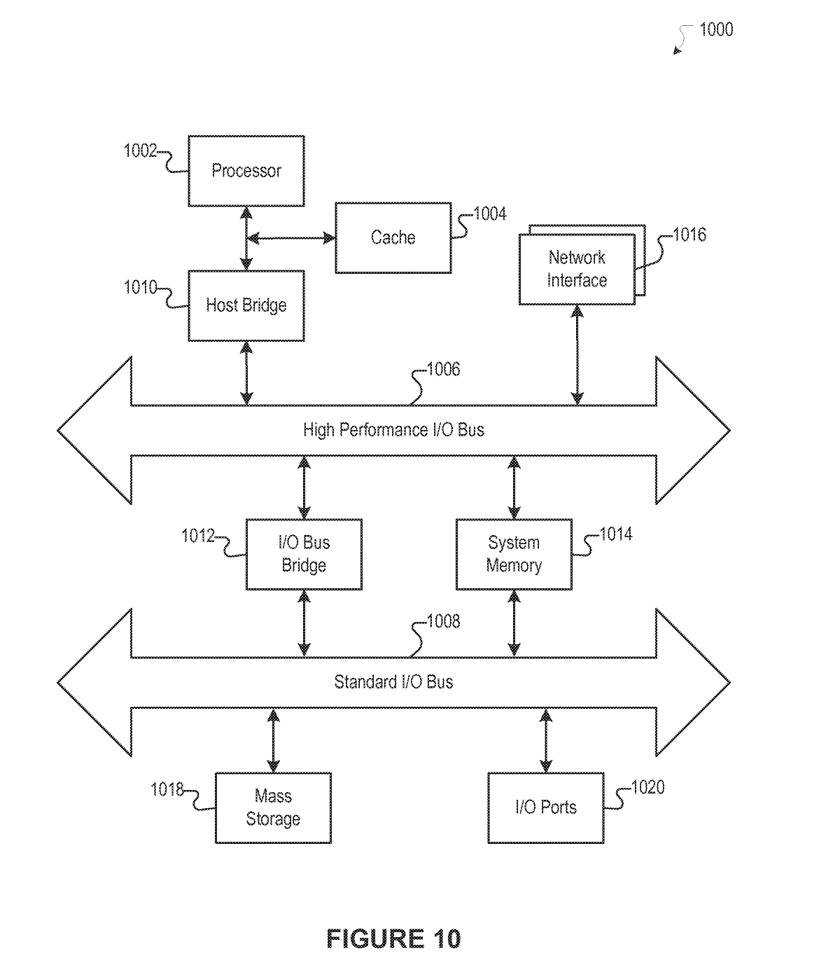

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 930, the user device 910, and the external system 1020, or a component thereof. In an embodiment of the invention, the computer system 1000 may be one server among many that constitutes all or part of the social networking system 930.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
capturing, by a computing system, media content including an original set of frames;
acquiring, by the computing system, motion data associated with the original set of frames;
determining, by the computing system, a motion pattern based on the motion data;
identifying, by the computing system, a subset of frames, out of the original set, that are associated with the motion pattern; and
providing, by the computing system, a time-lapse media content item based on the subset of frames that are associated with the motion pattern.

2. The computer-implemented method of claim 1, wherein the acquiring of the motion data associated with the original set of frames further comprises:
acquiring a set of timestamps associated with the original set of frames; and
acquiring a set of motion states from one or more motion sensors, wherein each motion state in the set of motion states is associated with a respective timestamp in the set of timestamps, and wherein the set of motion states is represented in the motion data associated with the original set of frames.

3. The computer-implemented method of claim 1, wherein the determining of the motion pattern based on the motion data further comprises:
analyzing the motion data to determine a set of motion states represented in the motion data; and
analyzing the set of motion states to select a subset of motion states that satisfy specified motion consistency criteria, wherein the motion pattern includes the subset of motion states.

4. The computer-implemented method of claim 3, wherein the identifying of the subset of frames, out of the original set, that are associated with the motion pattern further comprises:
identifying the subset of frames to include a plurality of frames, out of the original set of frames, that have timestamps corresponding to timestamps associated with the subset of motion states.

5. The computer-implemented method of claim 3, wherein the motion data is associated with a series of movements incurred by a user, wherein the series of movements includes a plurality of repeated movements, wherein the plurality of repeated movements is associated with the motion pattern, and wherein the specified motion consistency criteria require that each motion state in the subset of motion states is selected as being associated with a respective repeated movement in the plurality of repeated movements.

6. The computer-implemented method of claim 5, wherein the plurality of repeated movements includes a plurality of undesirable translational movements, and wherein the plurality of undesirable translational movements includes a plurality of undesired up-and-down movements.

7. The computer-implemented method of claim 5, wherein the series of movements incurred by the user is associated with at least one of walking, jogging, or running, and wherein the plurality of repeated movements is associated with at least one of an up-step, a down-step, or a recurring consistent movement present in the series of movements incurred by the user.

8. The computer-implemented method of claim 5, wherein the series of movements incurred by the user is associated with at least one of a bicycle ride, a motorcycle ride, an automobile ride, a boat ride, or a plane ride, and wherein the plurality of repeated movements is associated with a recurring consistent movement present in the series of movements incurred by the user.

9. The computer-implemented method of claim 1, further comprises:
applying an orientation-based image stabilization process to the subset of frames prior to the providing of the time-lapse media content item.

10. The computer-implemented method of claim 1, wherein the acquiring of the motion data utilizes at least one of an accelerometer, a gyroscope, a magnetometer, a barometer, or a compass.

11. A system comprising:
at least one processor; and
a memory storing instructions that, when executed by the at least one processor, cause the system to perform:
capturing media content including an original set of frames;
acquiring motion data associated with the original set of frames;
determining a motion pattern based on the motion data;
identifying a subset of frames, out of the original set, that are associated with the motion pattern; and
providing a time-lapse media content item based on the subset of frames that are associated with the motion pattern.

12. The system of claim 11, wherein the acquiring of the motion data associated with the original set of frames further comprises:
acquiring a set of timestamps associated with the original set of frames; and
acquiring a set of motion states from one or more motion sensors, wherein each motion state in the set of motion states is associated with a respective timestamp in the set of timestamps, and wherein the set of motion states is represented in the motion data associated with the original set of frames.

13. The system of claim 11, wherein the determining of the motion pattern based on the motion data further comprises:
analyzing the motion data to determine a set of motion states represented in the motion data; and
analyzing the set of motion states to select a subset of motion states that satisfy specified motion consistency criteria, wherein the motion pattern includes the subset of motion states.

14. The system of claim 13, wherein the identifying of the subset of frames, out of the original set, that are associated with the motion pattern further comprises:
identifying the subset of frames to include a plurality of frames, out of the original set of frames, that have timestamps corresponding to timestamps associated with the subset of motion states.

15. The system of claim 13, wherein the motion data is associated with a series of movements incurred by a user, wherein the series of movements includes a plurality of repeated movements, wherein the specified motion consistency criteria require that each motion state in the subset of motion states is selected as being associated with a respective repeated movement in the plurality of repeated movements.

16. A non-transitory computer-readable storage medium including instructions that, when executed by at least one processor of a computing system, cause the computing system to perform:
capturing media content including an original set of frames;
acquiring motion data associated with the original set of frames;
determining a motion pattern based on the motion data;
identifying a subset of frames, out of the original set, that are associated with the motion pattern; and
providing a time-lapse media content item based on the subset of frames that are associated with the motion pattern.

17. The non-transitory computer-readable storage medium of claim 16, wherein the acquiring of the motion data associated with the original set of frames further comprises:
acquiring a set of timestamps associated with the original set of frames; and
acquiring a set of motion states from one or more motion sensors, wherein each motion state in the set of motion states is associated with a respective timestamp in the set of timestamps, and wherein the set of motion states is represented in the motion data associated with the original set of frames.

18. The non-transitory computer-readable storage medium of claim 16, wherein the determining of the motion pattern based on the motion data further comprises:
analyzing the motion data to determine a set of motion states represented in the motion data; and
analyzing the set of motion states to select a subset of motion states that satisfy specified motion consistency criteria, wherein the motion pattern includes the subset of motion states.

19. The non-transitory computer-readable storage medium of claim 18, wherein the identifying of the subset of frames, out of the original set, that are associated with the motion pattern further comprises:
identifying the subset of frames to include a plurality of frames, out of the original set of frames, that have timestamps corresponding to timestamps associated with the subset of motion states.

20. The non-transitory computer-readable storage medium of claim 18, wherein the motion data is associated with a series of movements incurred by a user, wherein the series of movements includes a plurality of repeated movements, wherein the specified motion consistency criteria require that each motion state in the subset of motion states is selected as being associated with a respective repeated movement in the plurality of repeated movements.
